(19) United States
(12) Patent Application Publication
(10) Pub. No.: US 2025/0258145 A1
(43) Pub. Date: Aug. 14, 2025

(54) QUANTITATION OF ALKYLPHENOL ETHOXYLATE COMPOUNDS IN AQUEOUS SAMPLES

(71) Applicant: Siemens Healthcare Diagnostics Inc., Tarrytown, NY (US)

(72) Inventor: Andrew Malewicz, Norwalk, CT (US)

(73) Assignee: Siemens Healthcare Diagnostics Inc., Tarrytown, NY (US)

(21) Appl. No.: 18/856,428

(22) PCT Filed: Apr. 19, 2023
(86) PCT No.: PCT/US2023/019163

§ 371 Date: Oct. 11, 2024

Related U.S. Application Data
(60) Provisional application No. 63/363,315, filed on Apr. 20, 2022.

(51) Int. Cl. G01N 30/14; G01N 1/34; G01N 30/72

(52) U.S. Cl. CPC G01N 30/14; G01N 1/34; G01N 30/7233

(57) ABSTRACT

A method for determining an amount of alkylphenol ethoxylate compounds in an aqueous sample is provided. The aqueous sample is subjected to an extraction technique to produce a purified sample, the purified sample is subjected to a chemical cleavage technique to convert alkylphenol ethoxylate compounds in the purified sample to their corresponding alkylphenol compounds and produce a cleaved sample. The cleaved sample is subjected to a liquid chromatography technique to obtain a fraction enriched in alkylphenol compounds from the cleaved sample. The fraction enriched in alkylphenol compounds is ionized under conditions suitable to generate fragment ions detectable by mass spectrometry. The amount of the fragment ions is determined using mass spectrometry, and the amount of the fragment ions is related to the amount of alkylphenol ethoxylate compounds in the aqueous sample.

### CROSS-REFERENCE TO RELATED APPLICATION

This application claims priority or the benefit under 35 U.S.C. 119 of U.S. provisional patent application No. 63/363,315 filed on 20 Apr. 2022, the contents of which are fully incorporated herein by reference.

### FIELD OF THE INVENTION

The present disclosure relates to quantitation of alkylphenol ethoxylate compounds in aqueous samples using tandem mass spectrometry.

### BACKGROUND OF THE INVENTION

Alkylphenol ethoxylates are synthetic nonionic surfactants that have been used in a variety of industrial processes and consumer products as detergents, emulsifiers, dispersing agents and surface wetting agents. The aromatic alkylphenol portions of alkylphenol ethoxylate compounds are relatively nonpolar and can dissolve grease and other materials that have low solubility in water. On the other hand, the ethoxylate portions or chains of alkylphenol ethoxylate compounds are water-soluble and can help disperse dirt and grease from soiled surfaces into water. Alkylphenol ethoxylates may be introduced into aquatic environments, for example, via wastewater discharges, stormwater run-off, or from the application of pesticides.

Alkylphenol ethoxylates may be used as a detergent to lyse cells and extract proteins and organelles in biological samples and ultimately end up within a chemical analyzer waste stream. There is a need to determine the effectiveness of treatment strategies in removing this material from a chemical analyzer and/or waste stream thereof. Accordingly, there is a need to measure low concentrations of such materials.

Accordingly, there is a continuous need to detect for the presence of alkylphenol ethoxylate compounds and/or to quantify the amount of alkylphenol ethoxylate compounds in aqueous media, even at very low concentrations.

### SUMMARY OF THE INVENTION

Methods for determining an amount of alkylphenol ethoxylate compounds in one or more aqueous samples are provided herein. In embodiments, a method of the present disclosure includes steps (a)-(e) as set forth herein below. In step (a), an aqueous sample is subjected to an extraction technique to produce a purified or substantially purified sample including a concentrated amount of the alkylphenol ethoxylate compounds. In step (b), the purified sample is subjected to a chemical cleavage technique to convert alkylphenol ethoxylate compounds in the purified sample to their corresponding alkylphenol compounds and produce a cleaved sample. In step (c), the cleaved sample is subjected to a liquid chromatography technique to obtain a fraction enriched in alkylphenol compounds from the cleaved sample. In step (d), the fraction enriched in alkylphenol compounds is ionized under conditions suitable to generate fragment ions detectable by mass spectrometry. In step (e), the amount of the fragment ions is determined using mass spectrometry. The amount of fragment ions determined in step (e) is related to the amount of alkylphenol ethoxylate compounds in the aqueous sample. In embodiments, steps (a)-(e) occur in sequential order.

In embodiments, a suitable extraction technique includes a solid phase extraction technique. In the solid phase extraction technique, a volume of the aqueous sample may be applied to a solid sorbent material such that the one or more alkylphenol ethoxylate compounds in the aqueous sample adsorb onto the solid sorbent material. Volatile compounds including water may be removed from the solid support. The alkylphenol ethoxylate compounds may be eluted from the solid sorbent material by passing a polar aprotic organic solvent through the solid sorbent material to produce the purified or substantially purified sample. Volatile compounds including the polar aprotic organic solvent may be removed from the purified or substantially purified sample.

In embodiments, a solid sorbent material includes a polymeric adsorbent material.

In embodiments, a polar aprotic organic solvent includes an acetonitrile. Elution of the alkylphenol ethoxylate compounds from the solid sorbent material may be performed two or more times.

In embodiments, the solid phase extraction technique may be performed under vacuum.

In embodiments, prior to subjecting the aqueous sample to the solid phase extraction technique, the aqueous sample is centrifuged to separate the aqueous sample into a liquid phase and a solid phase. In embodiments, both the liquid phase and the solid phase may be applied to the solid sorbent material during the solid phase extraction technique.

In chemical cleavage technique embodiments, the purified sample is mixed with a cleaving agent to form a mixture. In embodiments, the mixture is incubated in an environment shielded from visible light. The cleaving agent may be removed from the mixture to form the cleaved sample. In embodiments, the cleaving agent includes boron tribromide.

The mixture may be incubated for a duration of greater than or equal to about 6 hours to less than or equal to about 24 hours.

The cleaving agent may be removed from the mixture by evaporating the cleaving agent therefrom at a temperature of about 65° C. under a flow of nitrogen gas until visible vapor production ceases.

In embodiments, the alkylphenol ethoxylate compounds in the aqueous sample may include 4-tert-Octylphenol ethoxylate compounds, and the alkylphenol compounds produced in step (b) may include 4-tert-Octylphenol compounds.

In embodiments, the methods as set forth herein may include, prior to step (c), introducing the cleaved sample into a basic solution. In embodiments, the basic solution includes an ammonium hydroxide solution including, by volume, about 0.005% NH₄OH. In embodiments, the basic solution has a pH greater than 7. In embodiments, the basic solution has a pH of 7.1 to 9, 7.2 to 8.5, 7.3 to 8. CONFIRM

In embodiments, prior to step (c), the cleaved sample is visually inspected, and the cleaved sample is discarded if it exhibits a pink or red color.

In embodiments, he liquid chromatography technique may be an ultra-performance liquid chromatography technique.

In the liquid chromatography technique, a continuous stream of a mobile phase eluent may be directed through a volume of a stationary solid phase. The cleaved sample may be introduced into the mobile phase eluent to form a fluid mixture. The fluid mixture may be passed through the stationary solid phase. An effluent may be collected from a downstream end of the stationary solid phase at a predetermined time for a predetermined duration to obtain the fraction enriched in alkylphenol compounds.

The liquid chromatography technique may be performed using a gradient elution profile. In such case, the mobile phase eluent may be formulated using individually and/or a mixture of a first mobile phase comprising an aqueous ammonium hydroxide (NH₄OH) solution and a second mobile phase comprising a nonaqueous ammonium hydroxide (NH₄OH) solution including a water-miscible organic solvent.

One or more parameters of the liquid chromatography technique may be controlled or adjusted such that the fraction enriched in alkylphenol compounds elutes from the downstream end of the stationary solid phase within a known duration.

The fraction enriched in alkylphenol compounds may be ionized in step (d) using atmospheric pressure chemical ionization.

The fraction enriched in alkylphenol compounds may be ionized in step (d) under basic conditions.

Mass spectrometry may be performed in step (e) in negative ion mode.

In step (d), the fraction enriched in alkylphenol compounds may be ionized to deprotonate the alkylphenol compounds and obtain precursor ions. The precursor ions may be fragmented to generate the fragment ions.

The alkylphenol compounds produced in step (b) may include 4-tert-Octylphenol compounds. In embodiments, the precursor ions may have a mass to charge ratio of about 205 and the fragment ions may have a mass to charge ratio of about 133.

Prior to step (c), a predetermined amount of an isotopically labeled internal standard may be added to the cleaved sample. The isotopically labeled internal standard may include an alkylphenol compound. In such case, in step (d), fragment ions may be generated from the alkylphenol compounds in the cleaved sample and from the isotopically labeled internal standard.

The amount of fragment ions generated from the alkylphenol compounds in the cleaved sample and the amount of fragment ions generated from the isotopically labeled internal standard may be separately detected by mass spectrometry.

In embodiments, the amount of alkylphenol compounds in the cleaved sample may be calculated by comparing the amount of the fragment ions generated from the alkylphenol compounds in the cleaved to the amount of fragment ions generated from the isotopically labeled internal standard

In embodiments, the amount of alkylphenol ethoxylate compounds in the aqueous sample may be calculated based on the amount of alkylphenol compounds in the cleaved sample.

In embodiments, steps (c), (d), and (e) may be performed sequentially with on-line processing.

In embodiments, the present disclosure includes a method for determining an amount of alkylphenol ethoxylate compounds in an aqueous sample is disclosed. The method includes steps (a)-(e). In step (a), the aqueous sample may be subjected to a solid phase extraction technique to produce an eluate including a concentrated amount of the alkylphenol ethoxylate compounds. In step (b), the eluate may be subjected to a chemical cleavage technique to convert alkylphenol ethoxylate compounds in the eluate to corresponding alkylphenol compounds and produce a cleaved sample. In step (c), the cleaved sample may be subjected to a liquid chromatography technique to produce an effluent. In step (d), a fraction of the effluent enriched in alkylphenol compounds may be subjected to tandem mass spectrometry. In step (e), the amount of alkylphenol compounds in the fraction of the effluent enriched in alkylphenol compounds may be determined. The amount of alkylphenol compounds determined in step (e) may be related to the amount of alkylphenol ethoxylate compounds in the aqueous sample.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 depicts a process flow diagram of a method embodiment for quantitation of alkylphenol ethoxylate compounds in aqueous samples including a sample preparation step, a chemical cleavage step, an internal standard addition step. a liquid chromatography step, a tandem mass spectrometry step, and a data analysis step.

FIGS. 2A-2B are ion chromatograms produced via tandem mass spectrometry of a blank reference sample; the chromatograms depict Relative Abundance (%) vs. Elution Time (minutes) for the transition pair 205.12>133.07 and the transition pair 211.12>139.07, respectively.

FIGS. 3A-3B are ion chromatograms produced via tandem mass spectrometry of a reference sample including 13C6-(benzene ring)-4-tert-Octylphenol as an internal standard; the chromatograms depict Relative Abundance (%) vs. Elution Time (minutes) for the transition pair 205.12>133.07 and the transition pair 211.12>139.07, respectively.

FIGS. 4A-4B are ion chromatograms produced via tandem mass spectrometry of a system waste sample including an unknown amount of 4-tert-Octylphenol ethoxylate and a known amount of 13C6-(benzene ring)-4-tert-Octylphenol as an internal standard; the chromatograms depict Relative Abundance (%) vs. Elution Time (minutes) for the transition pair 205.12>133.07 and the transition pair 211.12>139.07, respectively.

FIGS 5A-5B are ion chromatograms produced via tandem mass spectrometry of a system waste sample including a known amount of 4-tert-Octylphenol ethoxylate and a known amount of 13C6-(benzene ring)-4-tert-Octylphenol as an internal standard; the chromatograms depict Relative Abundance (%) vs. Elution Time (minutes) for the transition pair 205.12>133.07 and the transition pair 211.12>139.07, respectively.

FIGS. 6A-6B are a calibration curve depicting a linear relationship between the Response produced by the QC samples vs. the concentration of 4-tert-Octylphenol ethoxylate in the QC samples (calculated from the known concentration of 4-tert-Octylphenol in the as-prepared QC samples) and a plot of residuals.

FIG. 7 is an ion chromatogram produced via tandem mass spectrometry of a system waste sample containing an unknown amount of 4-tert-Octylphenol ethoxylate; the chromatogram depicts Relative Abundance (%) vs. Elution Time (minutes) for MRM transition 205.12>133.07.

FIG. 8 is an ion chromatogram produced via tandem mass spectrometry of the system waste sample of FIG. 7 after the sample was treated using Bio-Beads to remove of 4-tert-Octylphenol ethoxylate therefrom; the chromatogram depicts Relative Abundance (%) vs. Elution Time (minutes) for MRM transition 205.12>133.07.

FIGS. 9A-9B are a calibration curve depicting a linear relationship between the Response produced by Bio-Bead-treated system waste samples spiked with known amounts of 4-tert-Octylphenol ethoxylate vs. the total concentration of 4-tert-Octylphenol ethoxylate in the as-prepared samples and a plot of residuals.

FIG. 10 is a graph depicting the Average Response produced by Bio-Bead-treated and spiked system waste samples of FIG. 9A vs. the total concentration of 4-tert-Octylphenol ethoxylate in the as-prepared samples.

FIGS. 11A-11B are a calibration curve depicting a linear relationship between the Response produced by Bio-Bead-treated system waste samples spiked with known amounts of 4-tert-Octylphenol ethoxylate vs. the total concentration of 4-tert-Octylphenol ethoxylate in the as-prepared samples and a plot of residuals.

FIG. 12 is a graph depicting the Average Response produced by Bio-Bead-treated and spiked system waste samples of FIG. 11A vs. the total concentration of 4-tert-Octylphenol ethoxylate in the as-prepared samples.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

In embodiments, the methods of the present disclosure detect and/or quantify the amount of alkylphenol ethoxylate compounds in samples of various types of aqueous media. In embodiments, prior to analysis or process sequence, a solid phase extraction technique is used to purify or substantially purify the aqueous samples and to concentrate the alkylphenol ethoxylate compounds in the samples to a detectable amount. Alkylphenol ethoxylate compounds include a hydrophobic aromatic hydrocarbon group attached to a hydrophilic ethylene oxide chain and may exhibit a range of molecular weights depending upon the length of their ethylene oxide chains. Therefore, to account for this molecular weight variability, the purified and concentrated samples are subjected to a chemical cleavage technique in which the ethylene oxide chains are stripped from the alkylphenol ethoxylate compounds, converting the alkylphenol ethoxylate compounds to their corresponding alkylphenol compounds. In embodiments, the resulting alkylphenol compounds in the cleaved samples exhibit substantially the same molecular weights and may elute from a reverse phase liquid chromatography column at substantially the same time. In embodiments, the fraction of the effluent from the liquid chromatography column that is enriched in alkylphenol compounds is analyzed via tandem mass spectrometry using multiple reaction monitoring to determine the presence and/or amount of alkylphenol compounds in the effluent fraction. The amount of alkylphenol compounds in the effluent fraction can be used to determine the amount of alkylphenol ethoxylate compounds in the original aqueous samples. The accuracy and precision of quantitation is enabled by addition of an internal standard to the aqueous samples prior to passing the samples through the liquid chromatography column.

### Definitions

The use of the term “a” or “an” when used in conjunction with the term “comprising” in the claims and/or the specification may mean “one,” but it is also consistent with the meaning of “one or more,” “at least one,” and “one or more than one.” As such, the terms “a,” “an,” and “the” include plural referents unless the context clearly indicates otherwise. Thus, for example, reference to “a compound” may refer to one or more compounds, two or more compounds, three or more compounds, four or more compounds, or greater numbers of compounds. The term “plurality” refers to “two or more.”

The term “about” as used herein in reference to amounts or to quantitative measurements not including the measurement of the mass of an ion, refers to the indicated value plus or minus 10%. Mass spectrometry instruments can vary slightly in determining the mass of a given analyte. The term “about” in the context of the mass of an ion or the mass/charge ratio of an ion refers to +/−0.50 atomic mass unit.

The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used herein, the term “aqueous sample” refers to a sample including water. The aqueous sample can contain biological samples (e.g., cells, tissue, organs, organism, or parts thereof and the like) in it. These biological samples can be suspended or submerged in the aqueous sample. As used herein, the term “aqueous solution” refers to a solution in which the solvent is water.

The use of the term “or” in the claims is used to mean an inclusive “and/or” unless explicitly indicated to refer to alternatives only or unless the alternatives are mutually exclusive. For example, a condition “A or B” is satisfied by any of the following: A is true (or present) and B is false (or not present), A is false (or not present) and B is true (or present), and both A and B are true (or present).

As used herein, any reference to “one embodiment,” “an embodiment,” “some embodiments,” “one example,” “for example,” or “an example” means that a particular element, feature, structure, or characteristic described in connection with the embodiment is included in at least one embodiment. The appearance of the phrase “in some embodiments” or “one example” in various places in the specification is not necessarily all referring to the same embodiment, for example. Further, all references to one or more embodiments or examples are to be construed as non-limiting to the claims.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof”' is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein. the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “substantially purified”, as used herein, refers to alkylphenol ethoxylate compounds that are removed from an initial environment, isolated or separated, and are at least 60% free, at least 75% free, at least 90% free, at least 95% free, or at least 99% free from other components with which they are initially associated. CONFIRM ALL DEFINITIONS ABOVE IN THIS SECTION

### DETAILED DESCRIPTION OF CERTAIN EMBODIMENTS

Alkylphenol ethoxylate compounds that may be detected and quantitated in aqueous

samples using the presently disclosed methods may be represented by the following chemical formula:

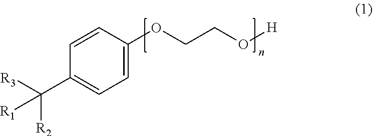

where n is an integer between 1 and 100, R₁ and R₂ are each C1-C12 branched or straight-chain alkyl groups, and R₃ is H or a C1-C9 branched or straight-chain alkyl group.

In aspects, the presently disclosed methods may be used to detect and quantitate 4-tert-Octylphenol ethoxylate compounds in aqueous samples. The 4-tert-Octylphenol ethoxylate compounds may be represented by the following chemical formula:

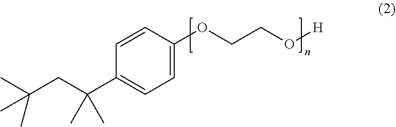

where n is an integer between 1 and 100.

In aspects, the presently disclosed methods may be used to detect and quantitate 4-tert-Octylphenol ethoxylate compounds represented by formula (2) above, where n is 9 or 10. Such compounds may be referred to as Triton® X-100.

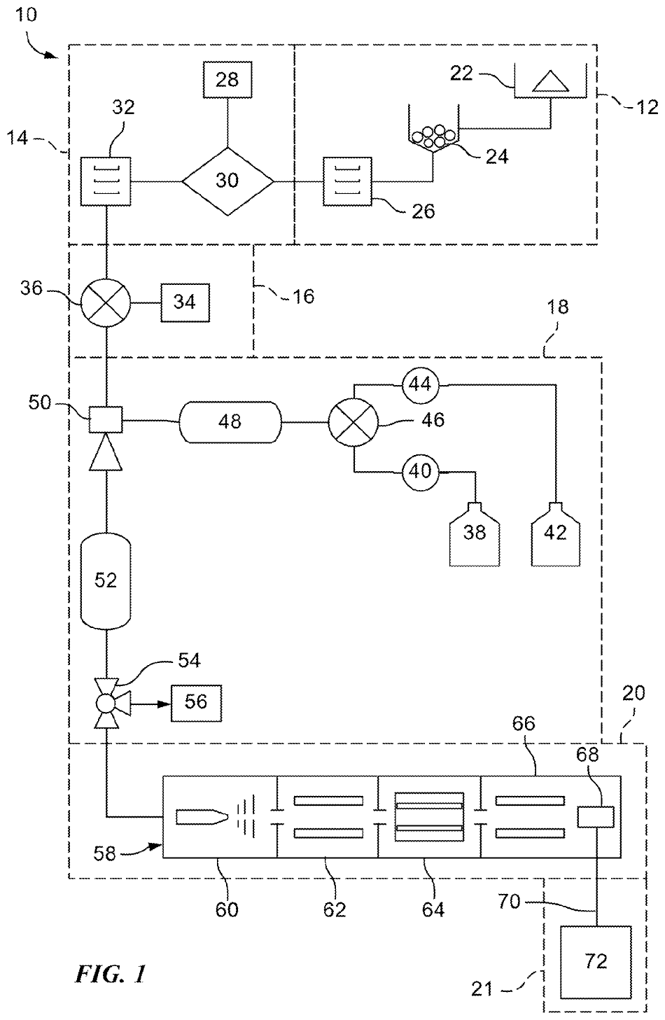

FIG. 1 is a process flow diagram of a method 10 for determining an amount of alkylphenol ethoxylate compounds in an aqueous sample. The method 10 includes a sample preparation step 12, a chemical cleavage step 14, an internal standard (IS) addition step 16, a liquid chromatography step 18, a tandem mass spectrometry step 20, and a data analysis step 21.

During the sample preparation step 12, the aqueous sample is subjected to one or more extraction techniques to purify the aqueous sample, to concentrate the alkylphenol ethoxylate compounds in the aqueous sample to a desirable amount, and to remove substances from the sample that might interfere with the subsequent liquid chromatography and/or tandem mass spectrometry steps 18, 20. The sample preparation step 12 may be performed using a centrifuge 22, a solid sorbent material 24, and an evaporation chamber 26. The aqueous sample may be purified by centrifugation in the centrifuge 22 to remove solid particulate matter therefrom. After centrifugation, the aqueous sample may be subjected to a solid phase extraction technique, which may include applying the aqueous sample to the solid sorbent material 24 to increase the concentration of the alkylphenol ethoxylate compounds in the aqueous sample. The solid sorbent material 24 may be made of a particulate material that is formulated to retain alkylphenol ethoxylate compounds thereon, for example, by adsorption, and to allow proteins and larger molecules to flow therethrough. In aspects. the solid sorbent material 24 may include a polymeric adsorbent material. The solid sorbent material 24 may be activated and conditioned prior to applying the aqueous sample to the solid sorbent material 24. In aspects, the solid sorbent material 24 may be activated by applying a polar aprotic organic solvent thereto, e.g., methanol, and subsequently conditioned by applying an aqueous ammonium hydroxide (NH₄OH) solution thereto. After the solid sorbent material 24 has been activated and conditioned, the aqueous sample may be applied thereto and dried under vacuum. After the aqueous sample is applied to the solid sorbent material 24, the solid sorbent material 24 may be dried to remove volatile compounds therefrom. The portion of the aqueous sample that initially passes through the solid sorbent material 24 after the aqueous sample is applied thereto may be discarded.

After the aqueous sample is applied to the solid sorbent material 24 such that the alkylphenol ethoxylate compounds contained therein have been adsorbed onto the solid sorbent material 24, the alkylphenol ethoxylate compounds may be eluted or extracted from the solid sorbent material 24, for example, using an eluent. The eluent may comprise a polar aprotic organic solvent, e.g., acetonitrile, methanol, acetone, or a combination thereof. The alkylphenol ethoxylate compounds may be eluted or extracted from the solid sorbent material 24 by applying the eluent to the solid sorbent material 24. The liquid eluate that passes through the solid sorbent material 24 may include a concentrated amount of the alkylphenol ethoxylate compounds. In aspects, the liquid eluate may be drawn through the solid sorbent material 24 by vacuum. The liquid eluate may be collected and evaporated to total dryness to produce a purified sample. Evaporation may be performed to remove volatile organic compounds from the liquid eluate, including the eluent, and may be performed at a temperature in a range of 60-65° C. in an inert environment, e.g., under a flow of nitrogen gas.

During the chemical cleavage step 14, the purified sample is subjected to a chemical cleavage technique to strip the ethylene oxide chains from the alkylphenol ethoxylate compounds in the purified sample and to convert the alkylphenol ethoxylate compounds to their corresponding alkylphenol compounds. The chemical cleavage step 14 may be performed by applying a cleaving agent 28 to the purified sample in a reactor 30. The purified sample and the cleaving agent 28 may be mixed in the reactor 30 to form a mixture. The mixture may be held in the reactor 30 and shielded from visible light for a duration in a range of 6-24 hours. Thereafter, the cleaving agent 28 may be evaporated from the mixture in a fume hood 32 to form a cleaved sample. Evaporation may be performed to total dryness at a temperature in a range of 60-65° C. in an inert environment, e.g., under a flow of nitrogen gas.

The cleaving agent 28 may include any chemical composition that can affect cleavage of the ethylene oxide chains from the alkylphenol ethoxylate compounds in the sample. In aspects, the cleaving agent 28 may include or consist of boron tribromide (BBr₃). The cleaving agent 28 may be applied to the purified sample in the reactor 30 in the form of a solution, e.g., a solution of 1.0 molar boron tribromide in methylene chloride.

The internal standard addition step 16 is performed to ensure the accuracy, precision, and reliability of the method 10 and includes adding an internal standard 34 to the cleaved sample. Addition of the internal standard 34 to the cleaved sample may be beneficial during the data analysis step 21, for example, by providing a reference that can be used to help correct and/or compensate for variations that might occur during the sample preparation step 12, the chemical cleavage step 14, the liquid chromatography step 18, and/or the tandem mass spectrometry step 20. A known amount of the internal standard 34 may be added to the cleaved sample and mixed with the cleaved sample in a mixer 36. The internal standard 34 may include a chemical compound that can be detected in the tandem mass spectrometry step 20 separately from the alkylphenol compounds in the cleaved sample. In aspects, the internal standard 34 may include an alkylphenol compound that has been labeled with a stable isotope, e.g., ¹³C, in the six carbons of its benzene ring.

During the internal standard addition step 16 or any time prior to the liquid chromatography step 18, the cleaved sample may be dissolved or dispersed in an aqueous solution having a pH of greater than or equal to about 10 to less than or equal to about 12. The aqueous solution may include water or a mixture of water and a water-miscible organic solvent, e.g., methanol and/or acetonitrile. The pH of the aqueous solution may be controlled or adjusted by addition of ammonium hydroxide (NH₄OH). In aspects, the cleaved sample may be dissolved or dispersed in a solution including, by volume, about 0.005% ammonium hydroxide in a mixture including about 25% water and about 75% of a water-miscible organic solvent.

Prior to the liquid chromatography step 18, a visual inspection of the cleaved sample may be performed. If the cleaved sample is found to exhibit a pink or red color after visual inspection, the sample may be discarded and a new aqueous sample may be prepared as described in steps 12, 14, and 16. In aspects, only cleaved samples that do not exhibit a pink or red color may be passed to the liquid chromatography step 18.

In the liquid chromatography step 18, the cleaved sample is subjected to a liquid chromatography technique to separate or fractionate the chemical compounds in the cleaved sample based upon the different partition coefficients of the chemical compounds and obtain a fraction of the cleaved sample that is enriched in alkylphenol compounds relative to the other chemical compounds in the cleaved sample. The liquid chromatography step 18 may be performed using a first mobile phase 38 in fluid communication with a first in-line pump 40, a second mobile phase 42 in fluid communication with a second in-line pump 44, a mixer 46, a delay column 48, an injector 50, a liquid chromatography column 52, and a three-way valve 54. A mobile phase eluent may be prepared from the first mobile phase 38, the second mobile phase 42, or as a mixture of the first and second mobile phases 38, 42. The first mobile phase 38 may include an aqueous ammonium hydroxide solution and the second mobile phase 42 may include a nonaqueous ammonium hydroxide solution including a water-miscible organic solvent. In aspects, the first mobile phase 38 may include, by volume, 0.005% ammonium hydroxide in water (H₂O) and the second mobile phase 42 may include, by volume, 0.005% ammonium hydroxide in methanol and/or acetonitrile. In aspects, the liquid chromatography step 18 may include subjecting the cleaved sample to an ultra-performance liquid chromatography (UPLC) technique.

In embodiments, a stationary solid phase is supported within the liquid chromatography column 52 and, in practice, a continuous stream of the mobile phase eluent is directed through the liquid chromatography column 52, from an inlet to an outlet thereof, and through the stationary solid phase supported therein. The stationary solid phase may include any material that can effectively separate the chemical compounds in the cleaved sample and obtain an effluent fraction enriched in alkylphenol compounds from the cleaved sample. In aspects, the stationary solid phase may include a packed bed of particles or a monolithic support structure with surface bonded alkyl groups, for example, the surfaces of the stationary solid phase may include C-18 bonded alkyl groups.

During the liquid chromatography step 18, the cleaved sample is introduced by the injector 50 into the continuous stream of the mobile phase eluent to form a fluid mixture. The fluid mixture is introduced into the inlet of the liquid chromatography column 52 and in contact with the stationary solid phase supported therein. Upon contact with the stationary solid phase, some of the chemical compounds in the fluid mixture will adsorb onto the surfaces of the stationary solid phase, while other chemical compounds in the fluid mixture will not. The continuous stream of the mobile phase eluent is supplied to the liquid chromatography column 52 throughout the entire liquid chromatography step 18 and, over time, chemical compounds that initially adsorbed onto the surfaces of the stationary solid phase will be released therefrom and will elute from the liquid chromatography column 52 as an effluent. The different chemical compounds in the fluid mixture will exhibit different retention times within the liquid chromatography column 52 based upon their different partition coefficients. The chemical compounds leaving the liquid chromatography column 52 in the effluent can be separated into fractions by collecting the effluent from the liquid chromatography column 52 at different times. In this way, a fraction of the effluent that is enriched in alkylphenol compounds relative to the other chemical compounds in the effluent can be obtained.

In aspects, the liquid chromatography step 18 may be performed using a gradient elution profile. In such case, the composition of the mobile phase eluent may be changed after the fluid mixture is introduced into the liquid chromatography column 52. For example, when the fluid mixture is introduced into the liquid chromatography column 52, the mobile phase eluent may have a composition that includes, by volume, greater than or equal to about 50% to less than or equal to about 100% of the first mobile phase 38 and greater than or equal to about 0% to less than or equal to about 50% of the second mobile phase 42. After the alkylphenol compounds in the fluid mixture have been adsorbed onto the stationary solid phase within the liquid chromatography column 52, the composition of the mobile phase eluent may be changed so that the mobile phase eluent has a composition that includes, by volume, greater than or equal to about 0% to less than or equal to about 50% of the first mobile phase 38 and greater than or equal to about 50% to less than or equal to about 100% of the second mobile phase 42. In aspects, when the fluid mixture is introduced into the liquid chromatography column 52, the mobile phase eluent may have a composition that includes, by volume, about 50% of the first mobile phase 38 and about 50% of the second mobile phase 42, and, after the fluid mixture is introduced into the liquid chromatography column 52, the mobile phase eluent may have a composition that includes, by volume, about 0% of the first mobile phase 38 and about 100% of the second mobile phase 42.

The retention time of the alkylphenol compounds from the cleaved sample in the liquid chromatography column 52 may be predetermined and may be controlled or adjusted, for example, based upon the composition of the stationary solid phase and/or of the mobile phase eluent. In aspects, after the alkylphenol compounds from the cleaved sample have been adsorbed onto the stationary solid phase within the liquid chromatography column 52, the composition of the mobile phase eluent may be changed to initiate release of the alkylphenol compounds therefrom. Based upon the known retention time of the alkylphenol compounds in the liquid chromatography column 52, a fraction of the effluent that is enriched in alkylphenol compounds from the cleaved sample can be obtained. The fraction of the effluent obtained from the cleaved sample during the liquid chromatography step 18 preferably includes the alkylphenol compounds derived from the initial aqueous sample and the isotopically labeled alkylphenol compounds from addition of the internal standard in step 16. Fractions of the effluent that are not enriched in alkylphenol compounds from the cleaved sample are not subjected to the tandem mass spectrometry step 20 and may be diverted to waste 5656, for example, by operation of the three-way valve 54.

The delay column 48 is positioned upstream of the injector 50 and is configured to control or adjust for the presence of any endogenous alkylphenol compounds that may be present in the mobile phase eluent. A stationary solid phase is supported within the delay column 48 and may comprise the same material as that of the liquid chromatography column 52.

The tandem mass spectrometry step 20 is performed to detect ions generated from the alkylphenol compounds in the cleaved sample. Based upon the detection of such ions, the amount of alkylphenol ethoxylate compounds present in the initial aqueous sample may be determined, for example, in the data analysis step 21. In aspects. the tandem mass spectrometry step 20 may be performed in multiple reaction monitoring (MRM) mode using a triple quadrupole mass spectrometer 58, which may include an ionization chamber 60, a first quadrupole mass filter 62, a collision cell 64, a second quadrupole mass filter 66, and an ion detector 68. The fraction of the effluent that is enriched in alkylphenol compounds is delivered from the outlet of the liquid chromatography column 52 to the ionization chamber 60 of the mass spectrometer 58. In the ionization chamber 60, the fraction of the effluent is ionized by an ionization source to produce a plurality of negatively charged ions, including a plurality of negatively charged alkylphenol ions. Ionization may be performed under basic conditions, e.g., at a pH of about 10, in negative ion mode by any suitable ionization method, for example, by atmospheric pressure chemical ionization (APCI).

The negatively charged ions produced in the ionization chamber 60 are passed to the first quadrupole mass filter 62. The first quadrupole mass filter 62 is tuned to separate out negative ions having a mass to charge ratio corresponding to that of the negatively charged alkylphenol compounds, including the negatively charged alkylphenol ions derived from the initial aqueous sample and the negatively charged isotopically labeled alkylphenol ions derived from the internal standard. In aspects, the alkylphenol ethoxylate compounds in the aqueous sample may comprise 4-tert-Octylphenol ethoxylate compounds, the negative ions derived from the 4-tert-Octylphenol ethoxylate compounds in the aqueous sample may exhibit a mass to charge ratio of about 205.12, the internal standard may comprise an isotopically labeled 4-tert-Octylphenol compound, and the negatively charged ions derived from the isotopically labeled 4-tert-Octylphenol compound may exhibit a mass to charge ratio of about 211.12. In such case, the first quadrupole mass filter 62 may be tuned to separate out negatively charged ions having a mass to charge ratio of about 205.12 and negatively charged ions having a mass to charge ratio of about 211.12. The negatively charged ions filtered out by the first quadrupole mass filter 62 may be referred to as precursor ions and may be allowed to pass from the first quadrupole mass filter 62 to the collision cell 64.

In the collision cell 64, the precursor ions collide with inert, neutrally charged gas molecules (e.g., argon, Ar) and are fragmented into one or more fragment ions. The mass to charge ratio of the fragment ions produced by fragmentation of the negatively charged alkylphenol ions and by fragmentation of the negatively charged isotopically labeled alkylphenol ions may be detected and analyzed, for example, by preparation of a total ion chromatogram, and the most abundant fragment ions produced may be selected and separated out by the second quadrupole mass filter 66. In aspects where the negatively charged precursor ions delivered to the collision cell 64 had a mass to charge ratio of about 205.12 or a mass to charge ratio of about 211.12, the second quadrupole mass filter 66 may be tuned to separate out negatively charged fragment ions having a mass to charge ratio of about 133.07 and negatively charged fragment ions having a mass to charge ratio of about 139.07. The negatively charged fragment ions filtered out by the second quadrupole mass filter 66 are detected by the ion detector 68, which generates an electric signal 70.

In the data analysis step 21, the electric signal 70 generated by the ion detector 68 may be relayed to a computer 72, which may be programmed to generate plots counts of the ions detected versus time, known as mass chromatograms. The mass chromatogram data may be related to the amount of the alkylphenol ethoxylate compounds in the original aqueous sample by numerous methods known in the art. For example, the areas under the peaks corresponding to the detected ions, or the amplitude of such peaks, may be measured and correlated to the amount of the alkylphenol ethoxylate compounds in the aqueous sample. In aspects, the area under the curves, or amplitude of the peaks, for the fragment ions and/or the precursor ions may be measured to determine the amount of the alkylphenol ethoxylate compounds in the aqueous sample. The relative abundance of a given ion may be converted into an absolute amount of the alkylphenol ethoxylate compounds in the aqueous sample using calibration standard curves based on peaks for the fragment ions and/or the precursor ions generated from the internal standard. Numerous other methods for relating the amount of an ion to the amount of the alkylphenol ethoxylate compounds in the original aqueous sample will be well known to those of ordinary skill in the art.

### Various Embodiments Of The Present Disclosure

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the extraction technique is a solid phase extraction technique, and wherein the solid phase extraction technique includes: applying a volume of the aqueous sample to a solid sorbent material such that the alkylphenol ethoxylate compounds in the aqueous sample adsorb onto the solid sorbent material; removing volatile compounds including water from the solid sorbent material; eluting the alkylphenol ethoxylate compounds from the solid sorbent material by passing a polar aprotic organic solvent through the solid sorbent material to produce the purified sample; and removing volatile compounds including the polar aprotic organic solvent from the purified sample.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the extraction technique is a solid phase extraction technique, and wherein the solid phase extraction technique includes: applying a volume of the aqueous sample to a solid sorbent material such that the alkylphenol ethoxylate compounds in the aqueous sample adsorb onto the solid sorbent material; removing volatile compounds including water from the solid sorbent material; eluting the alkylphenol ethoxylate compounds from the solid sorbent material by passing a polar aprotic organic solvent through the solid sorbent material to produce the purified sample; and removing volatile compounds including the polar aprotic organic solvent from the purified sample, wherein the solid sorbent material includes a polymeric adsorbent material.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the extraction technique is a solid phase extraction technique, and wherein the solid phase extraction technique includes: applying a volume of the aqueous sample to a solid sorbent material such that the alkylphenol ethoxylate compounds in the aqueous sample adsorb onto the solid sorbent material; removing volatile compounds including water from the solid sorbent material; eluting the alkylphenol ethoxylate compounds from the solid sorbent material by passing a polar aprotic organic solvent through the solid sorbent material to produce the purified sample; and removing volatile compounds including the polar aprotic organic solvent from the purified sample, wherein the polar aprotic organic solvent includes acetonitrile, and wherein elution of the alkylphenol ethoxylate compounds from the solid sorbent material is performed two or more times.

In embodiments, the present disclosure includes a method for determining an amount of alkylphenol ethoxylate compounds in an aqueous sample, the method including: (a) subjecting the aqueous sample to an extraction technique to produce a purified sample of substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the extraction technique is a solid phase extraction technique, and wherein the solid phase extraction technique includes: applying a volume of the aqueous sample to a solid sorbent material such that the alkylphenol ethoxylate compounds in the aqueous sample adsorb onto the solid sorbent material; removing volatile compounds including water from the solid sorbent material; eluting the alkylphenol ethoxylate compounds from the solid sorbent material by passing a polar aprotic organic solvent through the solid sorbent material to produce the purified sample; and removing volatile compounds including the polar aprotic organic solvent from the purified sample, wherein the solid phase extraction technique is performed under vacuum.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the extraction technique is a solid phase extraction technique, and wherein the solid phase extraction technique includes: applying a volume of the aqueous sample to a solid sorbent material such that the alkylphenol ethoxylate compounds in the aqueous sample adsorb onto the solid sorbent material; removing volatile compounds including water from the solid sorbent material; eluting the alkylphenol ethoxylate compounds from the solid sorbent material by passing a polar aprotic organic solvent through the solid sorbent material to produce the purified sample, and removing volatile compounds including the polar aprotic organic solvent from the purified sample, wherein prior to subjecting the aqueous sample to the solid phase extraction technique, the process includes centrifuging the aqueous sample to separate the aqueous sample into a liquid phase and a solid phase, wherein both the liquid phase and the solid phase are applied to the solid support during the solid phase extraction technique.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the chemical cleavage technique includes: mixing the purified sample with a cleaving agent to form a mixture; incubating the mixture in an environment shielded from visible light; and removing the cleaving agent from the mixture to form the cleaved sample. In embodiments, the cleaving agent includes or consists of boron tribromide. In embodiments, the mixture is incubated for a duration of greater than or equal to about 6 hours to less than or equal to about 24 hours, or between 7 and 20 hours, or between 8 and 16 hours. In embodiments, the cleaving agent is removed from the mixture by evaporating the cleaving agent therefrom at a temperature of about 65° C. under a flow of nitrogen gas until visible vapor production ceases.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein prior to step (c), the process sequence includes visually inspecting the cleaved sample and discarding the cleaved sample if it exhibits a pink or red color.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the liquid chromatography technique is an ultra-performance liquid chromatography technique. In embodiments, the liquid chromatography technique includes: directing a continuous stream of a mobile phase eluent through a volume of a stationary solid phase; introducing the cleaved sample into the mobile phase eluent to form a fluid mixture; passing the fluid mixture through the stationary solid phase; and collecting an effluent from a downstream end of the stationary solid phase at a predetermined time for a predetermined duration to obtain the fraction enriched in alkylphenol compounds. In embodiments, the liquid chromatography technique is performed using a gradient elution profile, wherein the mobile phase eluent is formulated using individually and/or a mixture of a first mobile phase including an aqueous ammonium hydroxide (NH₄OH) solution and a second mobile phase including a nonaqueous ammonium hydroxide (NH₄OH) solution including a water-miscible organic solvent. In embodiments, the process includes controlling or adjusting one or more parameters of the liquid chromatography technique such that the fraction enriched in alkylphenol compounds elutes from the downstream end of the stationary solid phase within a known duration.

In embodiments, the present disclosure includes a method for determining an amount of alkylphenol ethoxylate compounds in an aqueous sample, the method including: (a) subjecting the aqueous sample to an extraction technique to produce a purified sample of substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the fraction enriched in alkylphenol compounds is ionized in step (d) using atmospheric pressure chemical ionization, or wherein the fraction enriched in alkylphenol compounds is ionized in step (d) under basic conditions. In embodiments, the mass spectrometry is performed in step (e) in negative ion mode.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein step (d) further includes: ionizing the fraction enriched in alkylphenol compounds to deprotonate the alkylphenol compounds and obtain precursor ions; and fragmenting the precursor ions to generate the fragment ions. In embodiments, the alkylphenol compounds produced in step (b) include 4-tert-Octylphenol compounds, the precursor ions have a mass to charge ratio of about 205, and wherein the fragment ions have a mass to charge ratio of about 133.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein the method further includes prior to step (c), adding a predetermined amount of an isotopically labeled internal standard to the cleaved sample, the isotopically labeled internal standard comprising an alkylphenol compound, and wherein step (d) includes generating fragment ions from the alkylphenol compounds in the cleaved sample and from the isotopically labeled internal standard. In embodiments, the method includes separately detecting by mass spectrometry the amount of fragment ions generated from the alkylphenol compounds in the cleaved sample and the amount of fragment ions generated from the isotopically labeled internal standard; and calculating the amount of alkylphenol compounds in the cleaved sample by comparing the amount of the fragment ions generated from the alkylphenol compounds in the cleaved to the amount of fragment ions generated from the isotopically labeled internal standard. In embodiments the method includes calculating the amount of alkylphenol ethoxylate compounds in the aqueous sample based on the amount of alkylphenol compounds in the cleaved sample.

In embodiments, the present disclosure includes a method for determining an amount of alkylphenol ethoxylate compounds in an aqueous sample, the method including: (a) subjecting the aqueous sample to an extraction technique to produce a purified sample or substantially purified sample including a concentrated amount of the alkylphenol ethoxylate compounds; (b) subjecting the purified sample or substantially purified sample to a chemical cleavage technique to convert alkylphenol ethoxylate compounds in the purified sample or substantially purified sample to their corresponding alkylphenol compounds and produce a cleaved sample; (c) subjecting the cleaved sample to a liquid chromatography technique to obtain a fraction enriched in alkylphenol compounds from the cleaved sample; (d) ionizing the fraction enriched in alkylphenol compounds under conditions suitable to generate fragment ions detectable by mass spectrometry; and (e) determining the amount of the fragment ions using mass spectrometry, wherein the amount of fragment ions determined in step (e) is related to the amount of alkylphenol ethoxylate compounds in the aqueous sample, wherein steps (c), (d), and (e) are performed sequentially with on-line processing.

In embodiments, the present disclosure includes a method for determining an amount of alkylphenol ethoxylate compounds in an aqueous sample, the method including: (a) subjecting the aqueous sample to a solid phase extraction technique to produce an eluate including a concentrated amount of the alkylphenol ethoxylate compounds; (b) subjecting the eluate to a chemical cleavage technique to convert alkylphenol ethoxylate compounds in the eluate to corresponding alkylphenol compounds and produce a cleaved sample; (c) subjecting the cleaved sample to a liquid chromatography technique to produce an effluent; (d) subjecting a fraction of the effluent enriched in alkylphenol compounds to tandem mass spectrometry; and (e) determining the amount of alkylphenol compounds in the fraction of the effluent enriched in alkylphenol compounds, wherein the amount of alkylphenol compounds determined in step (e) is related to the amount of alkylphenol ethoxylate compounds in the aqueous sample.

### EXAMPLES

The following examples are merely illustrative, and do not limit this disclosure in any way.

System waste samples containing varying amounts of 4-tert-Octylphenol ethoxylate (oftentimes referred to as TRITON® X-100) were purified in a laboratory environment by centrifugation and solid phase extraction. The purified samples were subjected to a chemical cleavage technique to convert the 4-tert-Octylphenol ethoxylates in the samples to 4-tert-Octylphenol. The cleaved samples were analyzed using ultra performance liquid chromatography (UPLC) with tandem mass spectrometry (MS/MS) using multiple reaction monitoring (MRM), the results of which were used to detect and quantify the amount of 4-tert-Octylphenol ethoxylate present in the original system waste samples. Quantitation was performed by addition of an internal standard. The method was validated by preparing and analyzing reference blank samples, samples spiked within known amounts of 4-tert-Octylphenol ethoxylate, samples stripped of 4-tert-Octylphenol ethoxylate using Bio-Beads, and samples stripped of 4-tert-Octylphenol ethoxylate and subsequently spiked with known amounts of 4-tert-Octylphenol ethoxylate.

### Example 1

### Sample Purification and Concentration

System waste samples having a volume of 2 mL each were centrifuged for 10-15 minutes at 21,000×g to remove solid particulate matter therefrom. The solid particulate matter may include proteins, magnetic particles, and/or other solid particles and is assumed to be substantially free of 4-tert-Octylphenol ethoxylate.

The centrifuged system waste samples were subjected to a solid phase extraction technique to concentrate the 4-tert-Octylphenol ethoxylate in the samples to a detectable level and to remove interfering substances. Solid phase extraction was performed using a 96-well hydrophilic-lipophilic-balanced (HLB) sorbent extraction plate with 2 mg of a polypropylene powder adsorbent material having a particle size of 30 μm and a pore size of 80 Å (Waters 96-well Oasis HLB μElution plate, 30 μm).

Each well in the sorbent extraction plate was activated using 0.2 mL methanol (CH₃OH) and conditioned using 0.2 mL of an aqueous ammonium hydroxide (NH₄OH) solution including, by volume, 0.005% NH₄OH in water (H₂O). Then, the centrifuged system waste samples were individually added to the wells in the 96-well sorbent extraction plate and dried under vacuum for 5 minutes. The sorbent extraction plate retained 4-tert-Octylphenol ethoxylate while letting proteins and larger molecules flow through.

4-tert-Octylphenol ethoxylate was eluted from each of the samples in the sorbent extraction plate 3 times, using 0.1 mL acetonitrile for each elution. The eluate from each well was drawn by vacuum and transferred to individual glass vials. The wells in the 96-well sorbent extraction plate were each rinsed 2 times, using 0.2 mL acetonitrile each time, and then the acetonitrile used to rinse each of the wells was added to the corresponding glass vial with a PTFE septum. Each glass vial included a total eluate volume of 0.7 mL. The eluate in each vial was evaporated to total dryness at a temperature of 60-65° C. under a gentle flow of nitrogen.

### Example 2

### Chemical Cleavage

To each of the glass vials including the dried eluate from Example 1, 0.5 mL of a solution of 1.0 molar boron tribromide (BBr₃) in methylene chloride was added as a cleaving agent to convert the 4-tert-Octylphenol ethoxylate in the samples to 4-tert-Octylphenol. The glass vials were tightly capped and the eluate was thoroughly mixed with the BBr₃ solution to ensure the entire eluate sample was brought into solution. The eluate samples were incubated overnight (e.g., about 12 hours) with the BBr₃ solution in the glass vials and shielded from visible light. After incubation, the vials were opened and the BBr₃ solution was evaporated from the glass vials under low heat at 65° C., under a gentle flow of nitrogen in a fume hood until vapor production ceased and the vials were completely dry.

### Example 3

### Dilution and Addition of Internal Standard

After drying, the cleaved samples from Example 2 were reconstituted in 117 microliters (μL) of a solution including, by volume, 0.005% ammonium hydroxide (NH₄OH) in methanol (CH₃OH) and a predetermined amount of an internal standard of ¹³C6-(benzene ring)-4-tert-Octylphenol, labeled with ¹³C in the six carbons of the benzene ring). The concentration of the internal standard in each of the as-prepared samples was 12.8 ng/ml. 39 μL of a solution including, by volume, 0.005% ammonium hydroxide (NH₄OH) in water (H₂O) was added to the reconstituted samples to reduce the organic concentration to 75%. The reconstituted samples bad a total volume of 156 μL and a pH of about 10. Then, the samples were transferred to a 96-well liquid chromatography sample plate and their color was analyzed.

After reconstitution, the cleaved samples should be colorless. The presence of a pink or red color in any of the cleaved samples is believed to result from contamination of the samples or incomplete conversion of 4-tert-Octylphenol ethoxylate in the samples to 4-tert-Octylphenol. Samples exhibiting a pink or red color were not subjected to further analysis or otherwise used in determining the amount of 4-tert-Octylphenol ethoxylate in the original system waste samples. After cleavage, some of the samples developed a yellow color. Samples exhibiting a yellow color were analyzed in the following Examples and used in determining the amount of 4-tert-Octylphenol ethoxylate in the original system waste samples.

### Example 4

### Liquid Chromatography

After reconstitution and addition of the internal standard, the prepared samples from Example 3 were subjected to ultra-performance liquid chromatography (UPLC) by passing each sample through a C18 analytical column including a sorbent of ethylene bridged hybrid (BEH) particles having particle sizes of about 1.7 μm and pore sizes of about 130 Å (Waters ACQUITY UPLC BEH C18 Column, 130 Å, 1.7 μm, 2.1 mm×50 mm). The sorbent material used in the analytical column was selected due to its stability under basic conditions (e.g., marketed as being stable to pH 12 at 65° C.).

A C18 delay column (Waters Cortecs UPLC C18 1.6 μm VanGuard Pre-Column 2.1 mm×5 mm) was installed between the pump and the sample manager (upstream of the sample injection port) to account for the presence of octylphenols in the environmental and laboratory equipment and to shift any endogenous octylphenol peak from the sample peak.

The column was maintained at a temperature of 50° C. The mobile phase was controlled at a flow rate of 0.4 mL per minute and was formulated using a first mobile phase (Mobile Phase A), a second mobile phase (Mobile Phase B), or a mixture of the first and second mobile phases during the UPLC process. Mobile Phase A was an aqueous ammonium hydroxide (NH₄OH) solution including, by volume, 0.005% ammonium hydroxide (NH₄OH) in water (H₂O). Mobile Phase B was a nonaqueous ammonium hydroxide (NH₄OH) solution including, by volume, 0.005% ammonium hydroxide (NH₄OH) in methanol (CH₃OH). The mobile phase had a pH of about 10.

25 μL samples having a temperature of about 10° C. were injected into the mobile phase and passed through the C18 analytical column. For each sample, the UPLC process was performed for a run time of 6 minutes. At the time of sample injection (t=0), the composition of the mobile phase was formulated as a mixture including, by volume, 50% Mobile Phase A and 50% Mobile Phase B. Between time t=0.5 minutes and t=2.5 minutes, the concentration of Mobile Phase B in the mobile phase was increased linearly from 50% to 100% so that, at time t=2.5 minutes, the composition of the mobile phase was 100% Mobile Phase B. At time t=6 minutes, the composition of the mobile phase was returned to a mixture including, by volume, 50% Mobile Phase A and 50% Mobile Phase B.

The retention time in the analytical column for both the 4-tert-Octylphenol and the 13C6-(benzene ring)-4-tert-Octylphenol in the samples was estimated at 2.45±0.2 minutes. Therefore, during the time t=0 to t=1.5 minutes and during the time t=3.75 minutes to t=6 minutes, the effluent stream from the analytical column was diverted to waste and not passed to the ionization source. This was done to prevent possible contamination of the mass spectrometer with chemical compounds that might elute from the analytical column before or after the target analytes.

During the time t=1.5 minutes to t=3.75 minutes, the fraction of the effluent from the analytical column is enriched with the target analytes (i.e., 4-tert-Octylphenol and 13C6-(benzene ring)-4-tert-Octylphenol). This effluent fraction was further analyzed using tandem mass spectrometry to determine the concentration of the analytes therein.

To prevent carryover, the sample manager was washed with a mixture of methanol, acetonitrile, isopropanol, and water in a 40:25:25:10 volumetric ratio for 6-8 seconds after each sample was run.

### Example 5

### Tandem Mass Spectrometry

The fraction of the effluent from Example 4 that was enriched with 4-tert-Octylphenol and 13C6-(benzene ring)-4-tert-Octylphenol was analyzed using tandem mass spectrometry with multiple reaction monitoring (MRM) on a Waters Acquity H Class UPLC with Xevo TQ-S Micro Detector.

The fraction of the effluent from Example 4 was passed through an ionization source and ionization was performed using atmospheric pressure chemical ionization (APCI) under basic conditions (i.e., at a pH of about 10) and in negative ion mode. 4-tert-Octylphenol has a molecular weight of about 206.13 Daltons (Da) and 13C6-(benzene ring)-4-tert-Octylphenol has a molecular weight of about 212.13 Da. During ionization, the —OH group attached to the phenyl group of each octylphenol molecule is deprotonated. Therefore, after ionization, the effluent will contain 4-tert-Octylphenol ions having a mass to charge ratio (m/z) of about 205.12 and 13C6-(benzene ring)-4-tert-Octylphenol ions having a mass to charge ratio of about 211.12. The ionization source was operated at a corona discharge current of about 5.0 μA, a cone voltage of about 30 V, and a APCI probe temperature of about 550° C.

Detection and quantification of 4-tert-Octylphenol ions and 13C6-(benzene ring)-4-tert-Octylphenol ions in the samples was performed using multiple reaction monitoring (MRM) transitions. After ionization, the effluent was passed through a triple quadrupole mass spectrometer, including a first quadrupole mass filter, a collision cell, and a second quadrupole mass filter. The first quadrupole mass filter was tuned to separate out ions in the effluent gas stream having a mass to charge ratio of about 205.12 and ions having a mass to charge ratio of about 211.12. These parent or precursor ions were then fragmented in the collision cell using collision-induced dissociation (CID) and argon (Ar) as the inert gas with a collision energy of about 20V to form daughter or fragment ions.

The ion intensity of the fragment ions produced from each of the precursor ions was monitored and the most significant fragment ion produced from each of the precursor ions was selected for quantification. The most significant fragment ion produced by fragmentation of the 4-tert-Octylphenol ions had a mass to charge ratio of about 133.07 and the most significant fragment ion produced by fragmentation of the 13C6-(benzene ring)-4-tert-Octylphenol ions had a mass to charge ratio of about 139.07.

After fragmentation, the effluent stream was passed through a second quadrupole mass filter, which was tuned to separate out fragment ions having a mass to charge ratio of about 133.07 and ions having a mass to charge ratio of about 139.07. A photomultiplier was used to detect the fragment ions and generate an electric signal as output.

### Example 6

### Quantitation

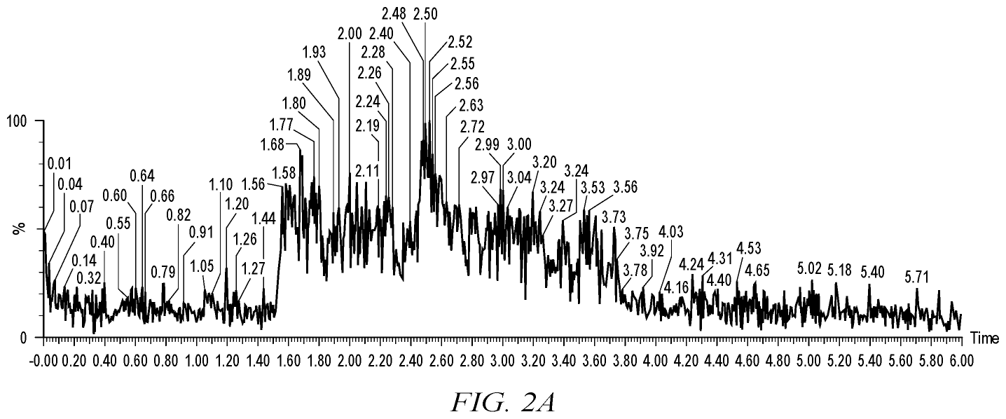

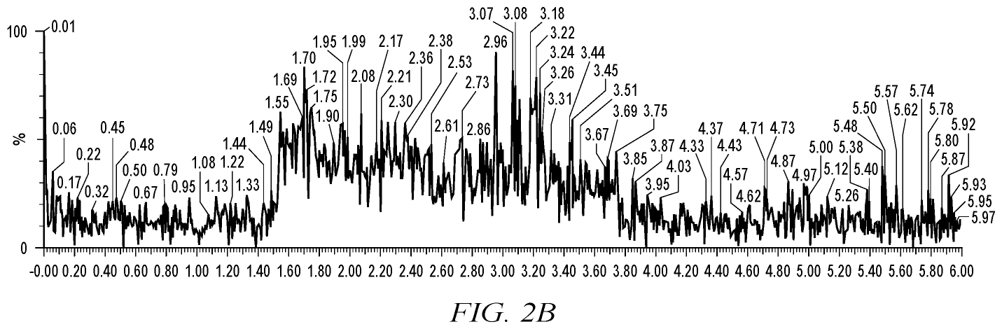

Using the output from the tandem mass spectrometry process described in Example 5, ion chromatograms were prepared depicting the relative abundance (%) of the target ions (using the transition pairs of 205.12>133.07 and 211.12>139.07) vs. the elution time (in minutes)). The chromatograms were integrated and processed using TargetLynx software. Chromatograms prepared using the transition pair of 205.12>133.07 identify the presence (or absence) of 4-tert-Octylphenol in the samples and can be used to calculate the amount of 4-tert-Octylphenol in the samples. Chromatograms prepared using the transition pair of 211.12>139.07 identify the presence (or absence) of 13C6-(benzene ring)-4-tert-Octylphenol in the samples and can be used for quantitation. Representative chromatograms are shown in FIGS. 2A-B, 3A-B, 4A-B, and 5A-B.

FIG. 2A depicts a chromatogram for MRM transition 205.12>133.07 and FIG. 2B depicts a chromatogram for MRM transition 211.12>139.07 of a blank reference sample including 25 μL of Mobile Phase B (0.005% ammonium hydroxide in methanol); this sample did not include 4-tert-Octylphenol ethoxylate or addition of an internal standard. The chromatograms confirms the absence of 4-tert-Octylphenol and 13C6-(benzene ring)-4-tert-Octylphenol in the blank reference sample.

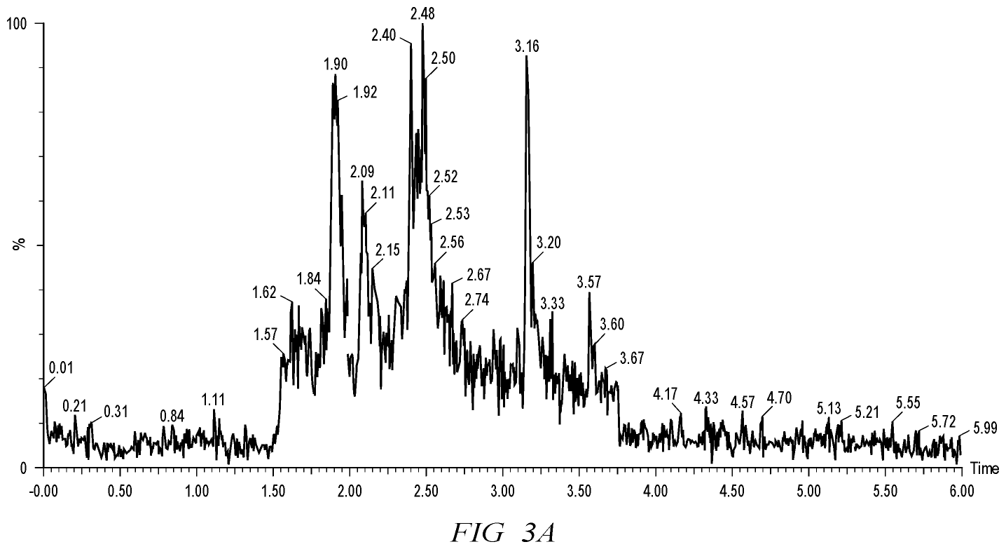

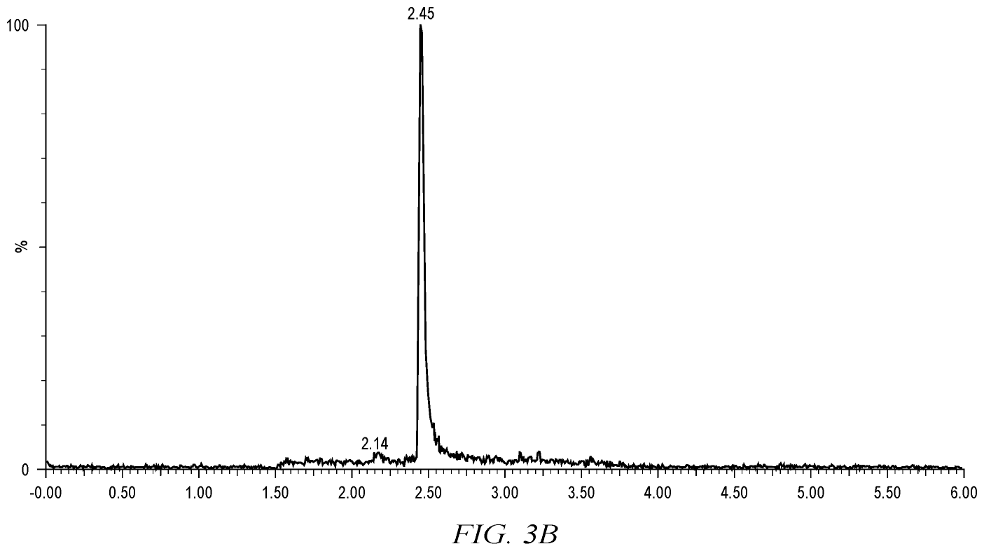

FIG. 3A depicts a chromatogram for MRM transition 205.12>133.07 and FIG. 3B depicts a chromatogram for MRM transition 211.12>139.07 of a reference sample including 12.8 ng/ml of the internal standard (13C6-(benzene ring)-4-tert-Octylphenol) in methanol; this sample did not include 4-tert-Octylphenol ethoxylate. In FIG. 3B, the peak at time t=2.45 minutes confirms the presence of the internal standard in the sample.

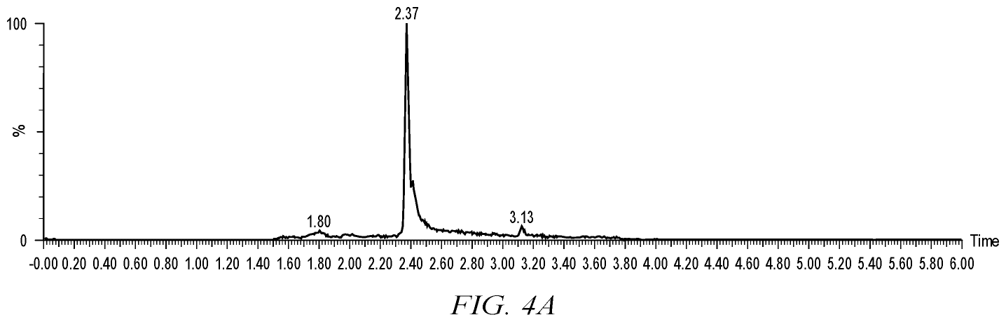

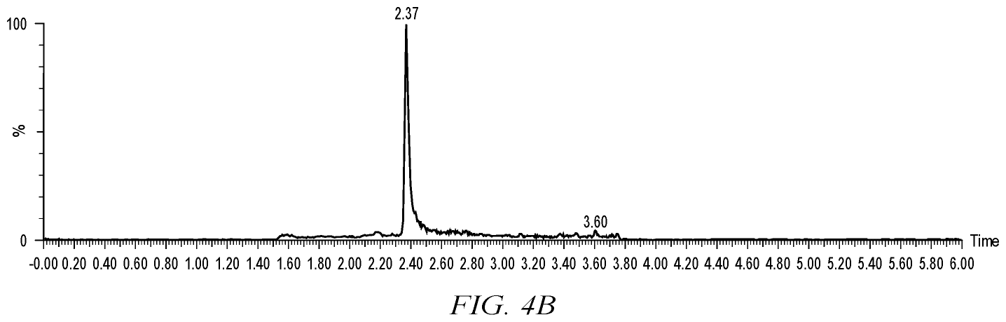

FIG. 4A depicts a chromatogram for MRM transition 205.12>133.07 and FIG. 4B depicts a chromatogram for MRM transition 211.12>139.07 of a system waste sample as prepared in Examples 1-5, initially including an unknown amount of 4-tert-Octylphenol ethoxylate and spiked with 12.8 ng/mL of the internal standard. In FIG. 4A, the peak at time t=2.37 minutes confirms the presence of 4-tert-Octylphenol in the sample and, in FIG. 4B, the peak at time t=2.37 minutes confirms the presence of the internal standard in the sample.

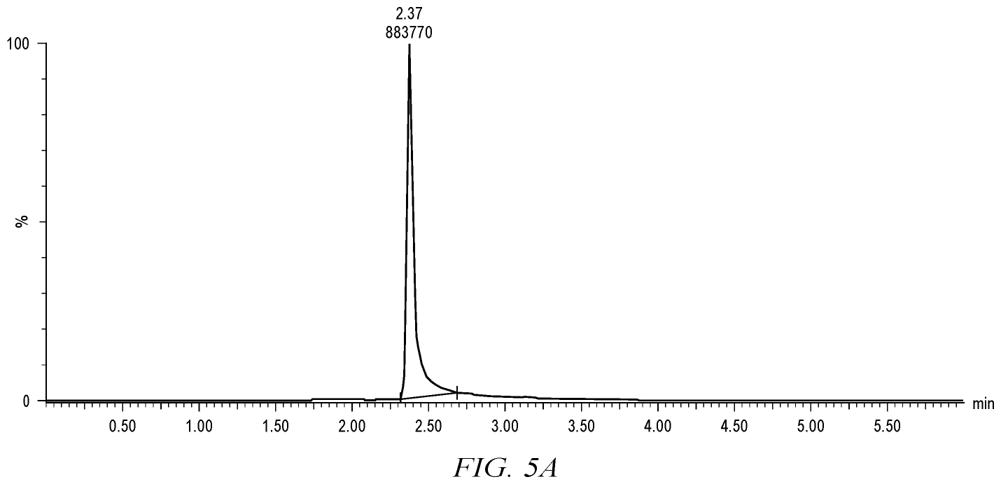

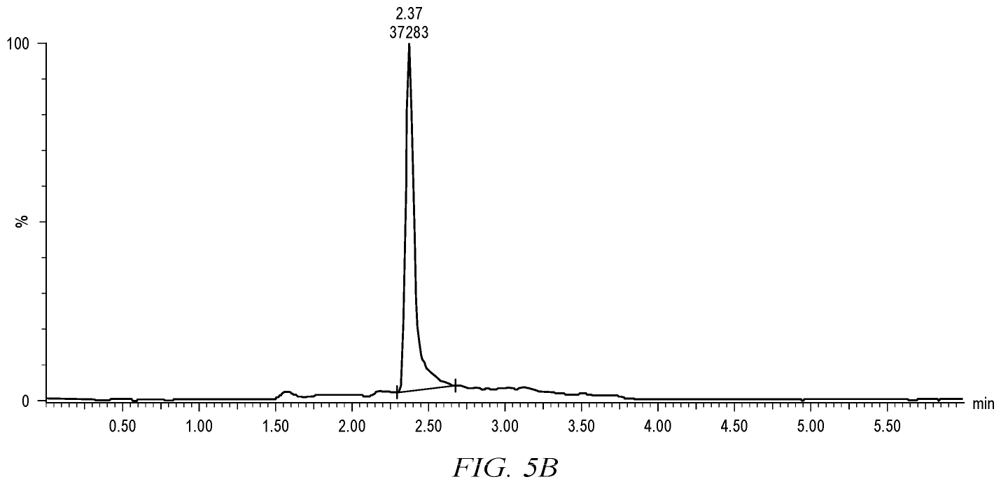

FIG. 5A depicts a chromatogram for MRM transition 205.12>133.07 and FIG. 5B depicts a chromatogram for MRM transition 211.12>139.07 of a calibration sample as prepared in Examples 1-5, initially including 7.5 ng/ml of 4-tert-Octylphenol ethoxylate and spiked with 12.8 ng/mL of the internal standard. As shown in FIG. 5A, the peak area of the 205.12>133.07 transition for the calibration sample was 883770, and, as shown in FIG. 5B, the peak area of the 211.12>139.07 transition for the calibration sample was 37283.

The concentration of 4-tert-Octylphenol in the system waste samples as prepared in Examples 1-5 may be determined from the ion chromatograms of the MRM transitions of 205.12>133.07 and 211.12>139.07 by normalizing the peak area of the 205.12>133.07 transition (corresponding to an unknown amount of 4-tert-Octylphenol) to the peak area of the 211.12>139.07 transition (corresponding to a known amount of the internal standard, 13C6-(benzene ring)-4-tert-Octylphenol).

To determine the concentration of 4 tert-Octylphenol ethoxylate present in the initial system waste samples (prior to treatment in Examples 1-3), the concentration of 4-tert-Octylphenol detected in the system waste samples is converted to the equivalent amount of 4-tert-Octylphenol ethoxylate. On a mass/volume context, one nanogram per milliliter of 4-tert-Octylphenol ethoxylate is the molar equivalent of 0.318 ng/ml of 4-tert-Octylphenol, using the standard molecular weight of 625 grams per mole (g/mol) for 4-tert-Octylphenol ethoxylate.

### Example 7

### Method Validation

Quality control (QC) samples including 0.5 ng/ml, 1.0 ng/mL, 2.0 ng/ml, 3.0 ng/mL, and 4.0 ng/mL of 4-tert-Octylphenol (analyte, A) and 12.8 ng/mL of the internal standard (IS) were prepared and analyzed as described in Examples 1-6. For each QC sample, the ratio of the peak area of the 205.12>133.07 transition (corresponding to the amount of 4-tert-Octylphenol in the QC sample) (PA_{A}) to the peak area of the 211.12>139.07 transition (corresponding to the amount of the internal standard in the QC sample) (PA_{IS}) was calculated as the response (i.e., Response=(PA_{A}/PA_{IS}).

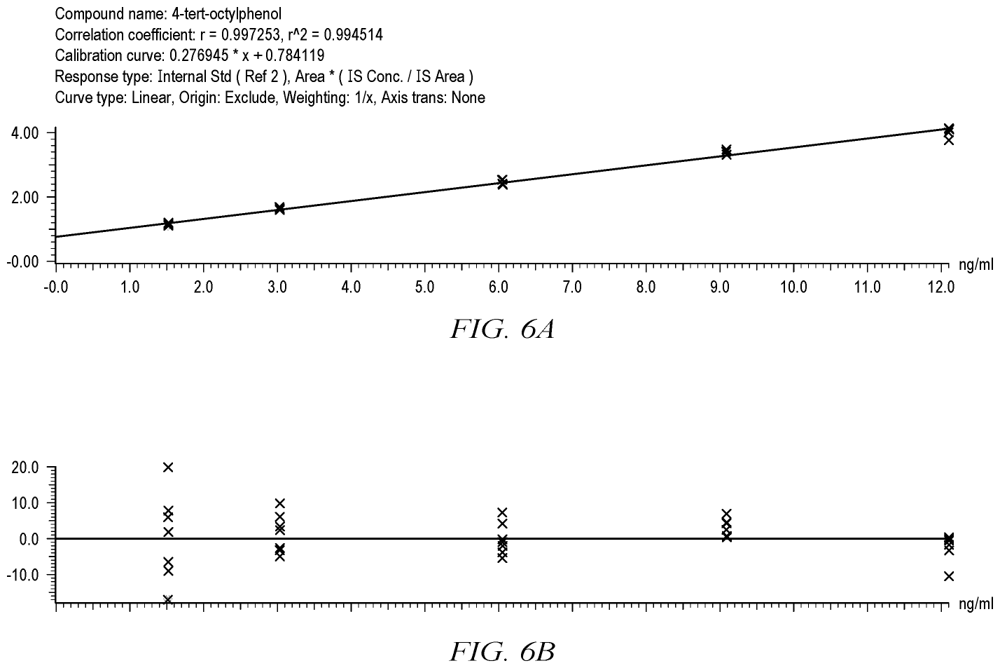

Referring now to FIG. 6A, a weighted linear regression analysis was performed to generate a calibration curve of the Response produced by the QC samples vs. the equivalent concentration of 4-tert-Octylphenol ethoxylate in the QC samples (i.e., about 1.57 ng/ml, 3.14 ng/ml, 6.29 ng/ml, 9.43 ng/mL, and 12.58 ng/mL) (calculated from the known concentration of 4-tert-Octylphenol in the as-prepared QC samples). With respect to linearity, the calibration curve exhibited a coefficient of correlation, r, of about 0.997253 and a coefficient of determination, r², of about 0.994514. As shown in FIG. 6A, the relationship between the Response (y) produced by a system waste sample and the equivalent concentration of 4-tert-Octylphenol ethoxylate (x) in the system waste sample can be modeled as y=0.276945*x+0.784119 using a weighting factor of 1/x. FIG. 6B, depicts a plot of residuals.

### Example 8

### Reproducibility and Precision

System waste samples containing unknown amounts of 4-tert-Octylphenol ethoxylate were treated using Bio-Beads SM-2 Resin (Bio-Beads), a nonpolar polystyrene adsorbent composed of analytical-grade, neutral, macroporous polymeric beads having a bead size in a range of 300 μm to 1,180 μm. 1 g of Bio-Beads was added to 100 mL of system waste in triplicate and mixed on a rotary mixer at room temperature for three hours. The Bio-Beads were removed from the system waste by filtering through a 0.2 μm bottle filter. Samples of untreated system waste and Bio-Bead-treated system waste were prepared as described in Examples 1-3 and analyzed using the techniques described in Examples 4-7.

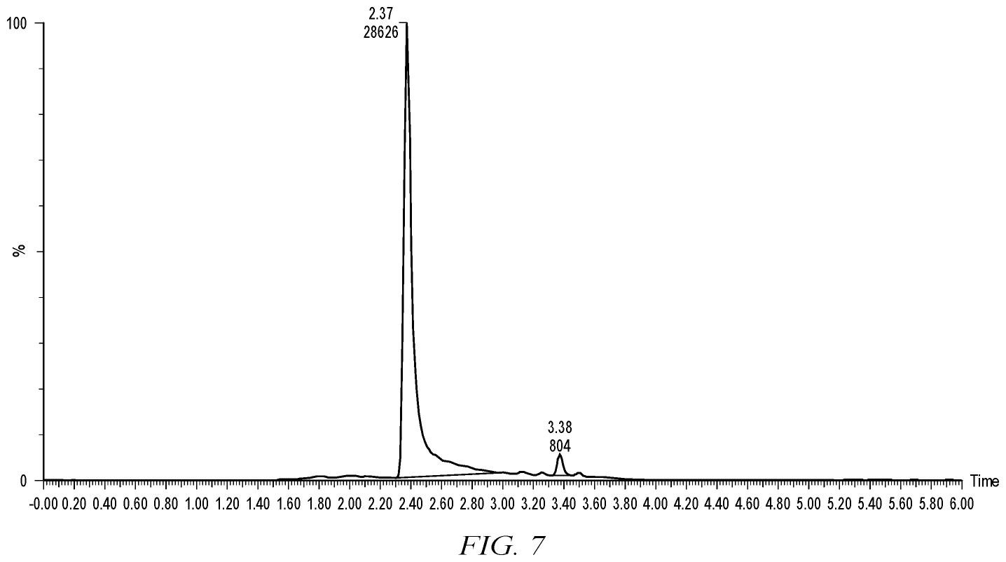

FIG. 7 depicts an ion chromatogram for MRM transition 205.12>133.07 of an untreated system waste sample as prepared in Examples 1-6. As shown in FIG. 7, the peak area of the 205.12>133.07 transition for this untreated sample had a peak area of about 28,626.

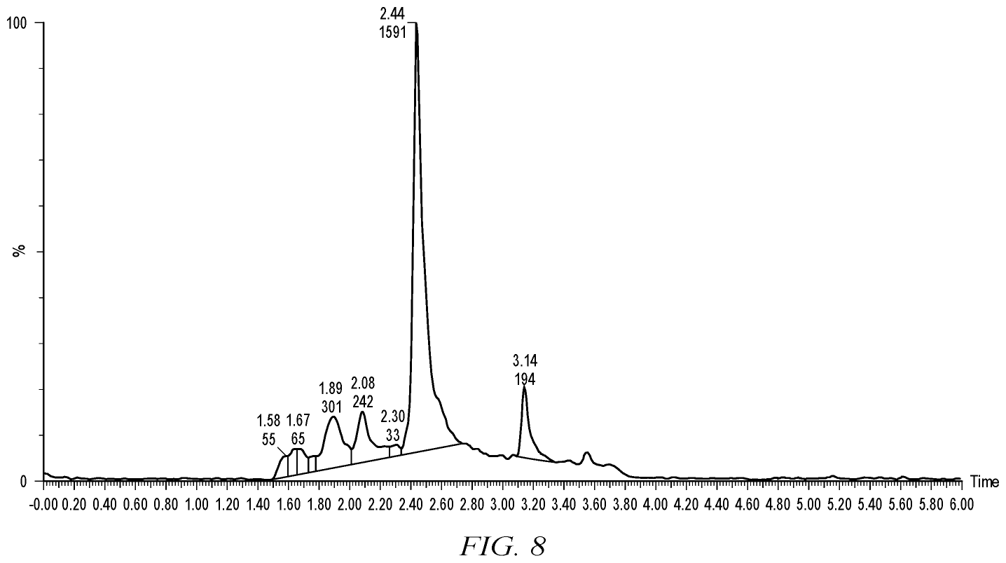

FIG. 8 depicts an ion chromatogram for MRM transition 205.12>133.07 of a Bio-Bead-treated system waste sample as prepared in Examples 1-6. As shown in FIG. 8, the peak area of the 205.12>133.07 transition for the Bio-Bead-treated sample had a peak area of about 1,591. Treatment of the system waste with Bio-Beads reduced the peak area by approximately 95%. Bio-Bead-treated system waste samples were used as blanks in the following examples.

To determine the reproducibility and lower limit of quantification, several samples of the Bio-Bead-treated system waste were spiked with known amounts of 4-tert-Octylphenol ethoxylate prior to centrifuging, solid phase extraction, chemical cleavage, dilution, and addition of the internal standard, as described in Examples 1-3 and analyzed using the techniques described in Examples 4-7.

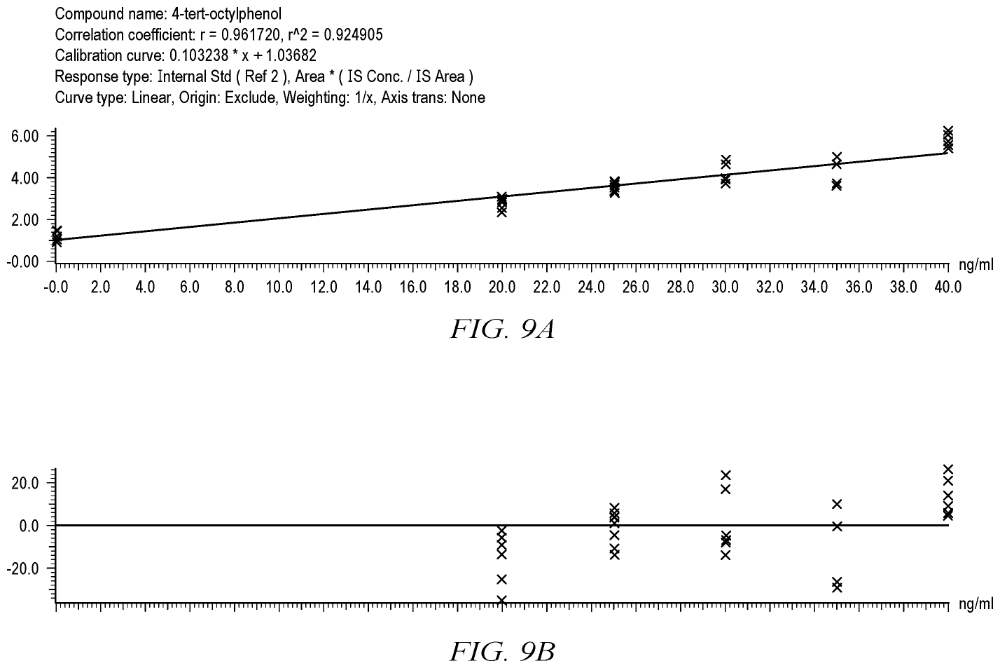

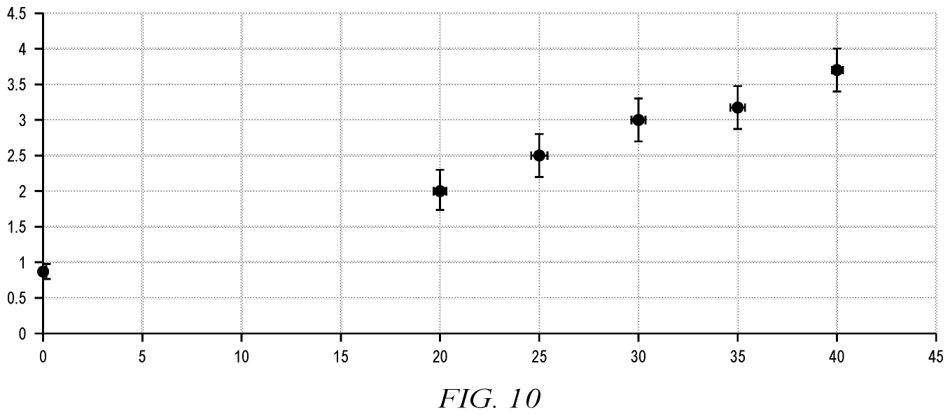

A first set of six 2 mL samples was prepared with four (4) replicates of each sample by spiking the Bio-Bead-treated system waste with 0 ng/ml, 10 ng/mL, 12.5 ng/ml, 15 ng/mL, 17.5 ng/mL, and 20 ng/ml of 4-tert-Octylphenol ethoxylate (0 ng, 20 ng, 25 ng, 30 ng, 35 ng, and 40 ng of total 4-tert-Octylphenol ethoxylate in each 2 mL sample). FIG. 9A is a calibration curve of the Response produced by the Bio-Bead-treated and spiked system waste samples vs. the total concentration of 4-tert-Octylphenol ethoxylate in the as-prepared samples. FIG. 9B, depicts a plot of residuals. FIG. 10 is a graph of Reproducibility. The coefficient of variation, CV (%), for the first set of six (6) samples was 11.8% (0 ng), 14.2% (20 ng), 15.0% (25 ng), 10.7% (30 ng), 10.9% (35 ng), and 7.5% (40 ng).

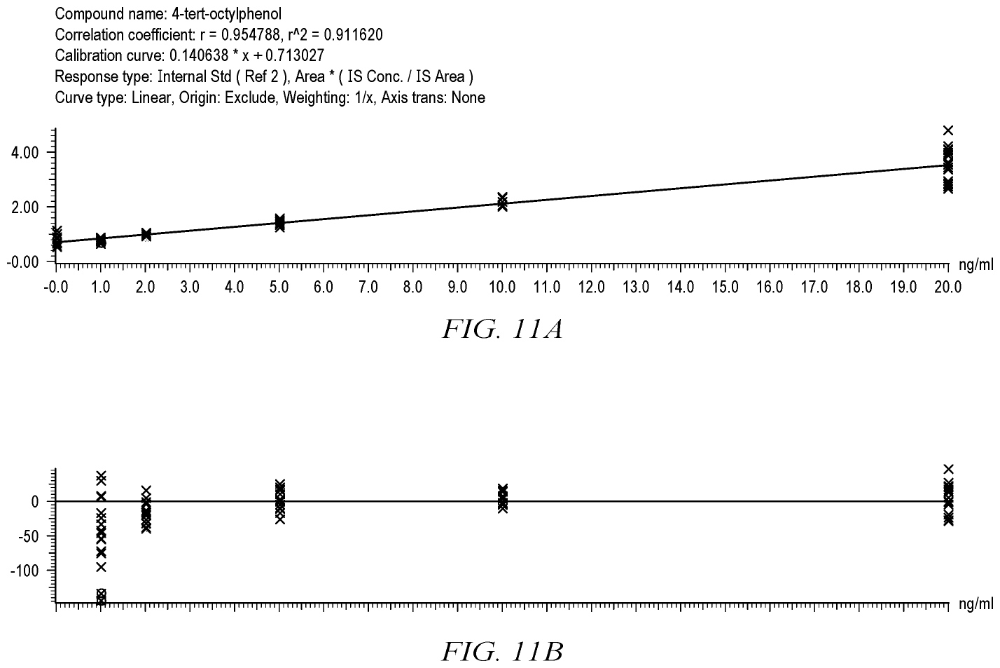

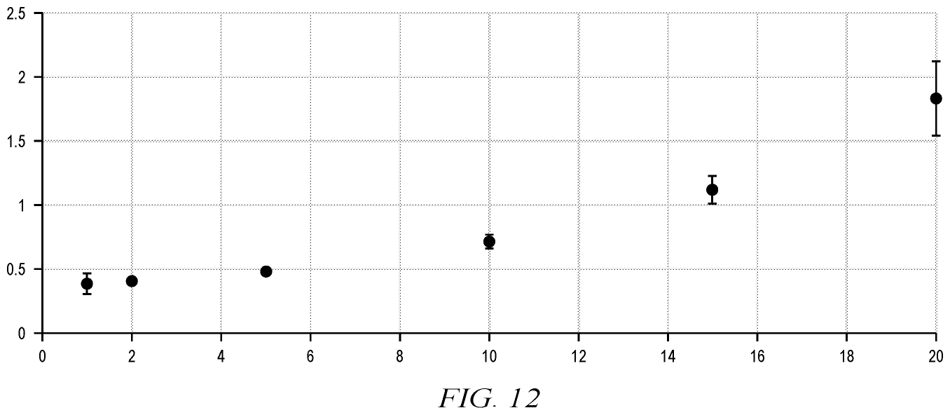

A second set of six 2 mL samples was prepared with four (4) replicates of each sample by spiking the Bio-Bead-treated system waste with 0.5 ng/ml, 1.0 ng/ml, 2.5 ng/ml., 5 ng/mL, 7.5 ng/mL, and 10 ng/ml of 4-tert-Octylphenol ethoxylate (1.0 ng, 2.0 ng, 5.0 ng, 10 ng, 15 ng, and 20 ng of total 4-tert-Octylphenol ethoxylate in each 2 mL sample). FIG. 11A is a calibration curve of the Response produced by the Bio-Bead-treated and spiked system waste samples vs. the total concentration of 4-tert-Octylphenol ethoxylate in the as-prepared samples. FIG. 11B, depicts a plot of residuals. FIG. 12 is a graph of Reproducibility. The coefficient of variation, CV (%), for the second set of samples was 21.5% (1 ng), 6.8% (2 ng), 4.4% (5 ng), 6.8% (10 ng), 9.7% (15 ng), and 16.0% (20 ng).

The lower limit of quantification was 500 ppt (0.5 ng/ml).

### Example 9

### Recovery

The amount of 4-tert-Octylphenol ethoxylate recovered during the solid phase extraction technique of Example 1 was determined by preparing four different 2 mL samples: (1) methanol only, (2) methanol including 20 ng total 4-tert-Octylphenol ethoxylate, (3) Bio-Bead-treated system waste, and (4) Bio-Bead treated system waste spiked with 20 ng 4-tert-Octylphenol ethoxylate

The methanol-containing samples (Samples 1 and 2) were prepared as described in Examples 2-3 (chemical cleavage, dilution, and addition of the internal standard) and analyzed using the techniques described in Examples 4-7. The methanol-containing samples were not subjected to the solid phase extraction technique of Example 1. The Bio-Bead-treated system waste samples (Samples 3 and 4) were prepared and analyzed as described in Examples 1-7, including the solid phase extraction technique of Example 1.

The amount of 4-tert-Octylphenol ethoxylate recovered during the solid phase extraction technique of Example 1 was determined by calculating the average response produced by each of the samples (Samples 1, 2, 3, and 4), subtracting the average response for Sample 1 from the average response for Sample 2 to obtain a nominalized blank response, subtracting the average response for Sample 3 from the average response for Sample 4 to obtain a nominalized system waste response, and then calculating the ratio of the nominalized blank response to the nominalized system waste response. Based upon this calculation method, the amount of 4-tert-Octylphenol ethoxylate recovered during the solid phase extraction technique of Example 1 was determined to be about 48%.

What is claimed is:

1. A method for determining an amount of alkylphenol ethoxylate compounds in an aqueous sample, the method comprising the following steps:
(a) subjecting the aqueous sample to an extraction technique to produce a purified sample including a concentrated amount of the alkylphenol ethoxylate compounds;
(b) subjecting the purified sample to a chemical cleavage technique to convert alkylphenol ethoxylate compounds in the purified sample to their corresponding alkylphenol compounds and produce a cleaved sample;
(c) subjecting the cleaved sample to a liquid chromatography technique to obtain a fraction enriched in alkylphenol compounds from the cleaved sample;
(d) ionizing the fraction enriched in alkylphenol compounds under conditions suitable to generate fragment ions detectable by mass spectrometry; and
(e) determining the amount of the fragment ions using mass spectrometry,
wherein the amount of fragment ions determined in step (e) is related to the amount of alkylphenol ethoxylate compounds in the aqueous sample.

2. The method of claim 1, wherein the extraction technique is a solid phase extraction technique, and wherein the solid phase extraction technique comprises:
applying a volume of the aqueous sample to a solid sorbent material such that the alkylphenol ethoxylate compounds in the aqueous sample adsorb onto the solid sorbent material;
removing volatile compounds including water from the solid sorbent material;
eluting the alkylphenol ethoxylate compounds from the solid sorbent material by passing a polar aprotic organic solvent through the solid sorbent material to produce the purified sample; and
removing volatile compounds including the polar aprotic organic solvent from the purified sample.

3. The method of claim 2, wherein the solid sorbent material comprises a polymeric adsorbent material.

4. The method of claim 2, wherein the polar aprotic organic solvent comprises acetonitrile, and wherein elution of the alkylphenol ethoxylate compounds from the solid sorbent material is performed two or more times.

5. The method of claim 2, wherein the solid phase extraction technique is performed under vacuum.

6. The method of claim 2 further comprising:
prior to subjecting the aqueous sample to the solid phase extraction technique, centrifuging the aqueous sample to separate the aqueous sample into a liquid phase and a solid phase, wherein both the liquid phase and the solid phase are applied to the solid support during the solid phase extraction technique.

7. The method of claim 1, wherein the chemical cleavage technique includes:
mixing the purified sample with a cleaving agent to form a mixture;
incubating the mixture in an environment shielded from visible light; and
removing the cleaving agent from the mixture to form the cleaved sample.

8. The method of claim 7, wherein the cleaving agent comprises boron tribromide.

9. The method of claim 7, wherein the mixture is incubated for a duration of greater than or equal to about 6 hours to less than or equal to about 24 hours.

10. The method of claim 7, wherein the cleaving agent is removed from the mixture by evaporating the cleaving agent therefrom at a temperature of about 65° C. under a flow of nitrogen gas until visible vapor production ceases.

11. The method of claim 1, wherein the alkylphenol ethoxylate compounds in the aqueous sample comprise 4-tert-Octylphenol ethoxylate compounds, and wherein the alkylphenol compounds produced in step (b) comprise 4-tert-Octylphenol compounds.

12. The method of claim 1 further comprising:
prior to step (c), introducing the cleaved sample into a basic solution.

13. The method of claim 12, wherein the basic solution comprises an ammonium hydroxide solution comprising, by volume, about 0.005% NH₄OH.

14. The method of claim 1 further comprising:
prior to step (c), visually inspecting the cleaved sample and discarding the cleaved sample if it exhibits a pink or red color.

15. The method of claim 1, wherein the liquid chromatography technique is an ultra-performance liquid chromatography technique.

16. The method of claim 1, wherein the liquid chromatography technique comprises:
directing a continuous stream of a mobile phase eluent through a volume of a stationary solid phase;
introducing the cleaved sample into the mobile phase eluent to form a fluid mixture;
passing the fluid mixture through the stationary solid phase; and
collecting an effluent from a downstream end of the stationary solid phase at a predetermined time for a predetermined duration to obtain the fraction enriched in alkylphenol compounds.

17. The method of claim 16, wherein the liquid chromatography technique is performed using a gradient elution profile, wherein the mobile phase eluent is formulated using individually and/or a mixture of a first mobile phase comprising an aqueous ammonium hydroxide (NH₄OH) solution and a second mobile phase comprising a nonaqueous ammonium hydroxide (NH₄OH) solution including a water-miscible organic solvent.

18. The method of claim 16 further comprising:
controlling or adjusting one or more parameters of the liquid chromatography technique such that the fraction enriched in alkylphenol compounds elutes from the downstream end of the stationary solid phase within a known duration.

19. The method of claim 1, wherein the fraction enriched in alkylphenol compounds is ionized in step (d) using atmospheric pressure chemical ionization.

20. The method of claim 1, wherein the fraction enriched in alkylphenol compounds is ionized in step (d) under basic conditions.

21. The method of claim 1, wherein mass spectrometry is performed in step (e) in negative ion mode.

22. The method of claim 1, wherein step (d) further comprises:
ionizing the fraction enriched in alkylphenol compounds to deprotonate the alkylphenol compounds and obtain precursor ions; and
fragmenting the precursor ions to generate the fragment ions.

23. The method of claim 22, wherein the alkylphenol compounds produced in step (b) comprise 4-tert-Octylphenol compounds, the precursor ions have a mass to charge ratio of about 205, and wherein the fragment ions have a mass to charge ratio of about 133.

24. The method of claim 1 further comprising:
prior to step (c), adding a predetermined amount of an isotopically labeled internal standard to the cleaved sample, the isotopically labeled internal standard comprising an alkylphenol compound, and
wherein step (d) comprises generating fragment ions from the alkylphenol compounds in the cleaved sample and from the isotopically labeled internal standard.

25. The method of claim 24 further comprising:
separately detecting by mass spectrometry the amount of fragment ions generated from the alkylphenol compounds in the cleaved sample and the amount of fragment ions generated from the isotopically labeled internal standard; and
calculating the amount of alkylphenol compounds in the cleaved sample by comparing the amount of the fragment ions generated from the alkylphenol compounds in the cleaved to the amount of fragment ions generated from the isotopically labeled internal standard.

26. The method of claim 25 further comprising:
calculating the amount of alkylphenol ethoxylate compounds in the aqueous sample based on the amount of alkylphenol compounds in the cleaved sample.

27. The method of claim 1 wherein steps (c), (d), and (e) are performed sequentially with on-line processing.

28. A method for determining an amount of alkylphenol ethoxylate compounds in an aqueous sample, the method comprising the following steps:
(a) subjecting the aqueous sample to a solid phase extraction technique to produce an eluate including a concentrated amount of the alkylphenol ethoxylate compounds;
(b) subjecting the eluate to a chemical cleavage technique to convert alkylphenol ethoxylate compounds in the eluate to corresponding alkylphenol compounds and produce a cleaved sample;
(c) subjecting the cleaved sample to a liquid chromatography technique to produce an effluent;
(d) subjecting a fraction of the effluent enriched in alkylphenol compounds to tandem mass spectrometry; and
(e) determining the amount of alkylphenol compounds in the fraction of the effluent enriched in alkylphenol compounds,
wherein the amount of alkylphenol compounds determined in step (e) is related to the amount of alkylphenol ethoxylate compounds in the aqueous sample.
